(19) United States
(12) Patent Application Publication
(10) Pub. No.: US 2026/0370967 A1
(43) Pub. Date: Nov. 19, 2026

(54) IMAGING DEVICE AND CORRECTION METHOD THEREOF

(71) Applicant: SK hynix Inc., Icheon-si (KR)

(72) Inventors: Gon Ji LEE, Icheon-si (KR); Hyung Jun HAN, Icheon-si (KR)

(21) Appl. No.: 19/401,225

(22) Filed: Nov. 25, 2025

(30) Foreign Application Priority Data
May 19, 2025 (KR) 10-2025-0064719

(51) Int. Cl. H04N 25/671

(52) U.S. Cl. CPC H04N 25/671

(57) ABSTRACT

Image correction devices and methods for operating the same are disclosed. In an embodiment, an image correction method includes: receiving dark pixel values corresponding to pixel signals generated under a dark condition by a plurality of pixels arranged in a matrix structure; determining a plurality of first average values, each first average value corresponding to an average of the dark pixel values of pixels in a respective first pixel group, each first pixel group being a set of pixels arranged in a line in a first direction within the matrix structure; determining first delta values by subtracting a first reference value from each of the plurality of first average values; and generating first corrected pixel values by adjusting each of the dark pixel values using the first delta values.

### PRIORITY CLAIM AND CROSS-REFERENCE TO RELATED APPLICATION

This patent document claims the priority and benefits of Korean patent application No. 10-2025-0064719, filed on May 19, 2025, the disclosure of which is incorporated herein by reference in its entirety as part of the disclosure of this patent document.

### TECHNICAL FIELD

The technology and embodiments disclosed in this patent document generally relate to an imaging device and an image correction method.

### BACKGROUND

Image sensors are devices that capture images using the properties of semiconductors that respond to light. With the recent development of information technology (IT) industries and related technologies, the demand for high-quality, high-performance image sensors is rapidly increasing in various electronic devices such as smartphones, digital cameras, etc.

Image sensors may be broadly classified into charge coupled device (CCD)-based image sensors and complementary metal oxide semiconductor (CMOS)-based image sensors. Recently, CMOS image sensors have been intensively researched and are coming into widespread use.

### SUMMARY

Various embodiments of the disclosed technology relate to the imaging device that can prevent the occurrence of incorrect images caused by non-uniform noise generated in a pixel array.

In an embodiment of the disclosed technology, an image correction method may include: receiving, by an image correction device, from a plurality of pixels arranged in a matrix structure, dark pixel values corresponding to pixel signals generated under a dark condition by the plurality of pixels; processing the received dark pixel values, by the image correction device, to determine a plurality of first average values for first pixel groups each being a set of pixels arranged in a line in a first direction within the matrix structure, wherein each first average value corresponds to an average of the dark pixel values of pixels in a respective first pixel group within the plurality of pixels arranged in the matrix structure; determining, by the image correction device, one or more first delta values by subtracting a first reference value from each of the plurality of first average values; and generating, by the image correction device, first corrected pixel values by adjusting each of the dark pixel values using the first delta values.

In some implementations, the determining the first delta values may include: calculating the first delta values by using a median value of the plurality of first average values as the first reference value.

In some implementations, the determining the first delta values may include: calculating the first delta values by using an average of the plurality of first average values as the first reference value.

In some implementations, the image correction method may further include: determining, by the image correction device, a plurality of second average values, each second average value corresponding to an average of the dark pixel values of pixels in a respective second pixel group, each second pixel group being a set of pixels arranged in a line in a second direction different from the first direction within the matrix structure; determining, by the image correction device, one or more second delta values by subtracting a second reference value from each of the plurality of second average values; and generating, by the image correction device, second corrected pixel values by adjusting each of the first corrected pixel values using the second delta value.

In some implementations, the calculating the second delta value may include: calculating the second delta value by using a median value of the plurality of second average values as the second reference value.

In some implementations, the determining the second delta value may include: calculating the second delta value by using an average of the plurality of second average values as the second reference value.

In some implementations, the determining the first delta values may include: calculating the first delta value by using a preset offset value as the first reference value, and the determining the second delta value may include: calculating the second delta value by using the preset offset value as the second reference value.

In some implementations, the generating the second corrected pixel values may include: calculating the second corrected pixel values by subtracting the second delta value from the first corrected pixel value of each of the plurality of pixels.

In some implementations, the generating the first corrected pixel values may include: calculating the first corrected pixel values by subtracting the first delta value from the dark pixel value of each of the plurality of pixels.

In another embodiment of the disclosed technology, an image correction device may include: a pixel data receiver configured to receive dark pixel values corresponding to pixel signals generated under a dark condition by a plurality of pixels arranged in a matrix structure; a pixel data calculator configured to determine a plurality of first average values, each first average value corresponding to an average of the dark pixel values of pixels in a respective first pixel group, each first pixel group being a set of pixels arranged in a line in a first direction within the matrix structure; a parameter determiner configured to determine one or more first delta values by subtracting a first reference value from each of the plurality of first average values; and a pixel data corrector configured to generate first corrected pixel values by adjusting each of the dark pixel values using the first delta value.

In some implementations, the first direction may be a row direction in the matrix structure.

In some implementations, the first direction may be a column direction in the matrix structure.

In some implementations, the first reference value may be an average of the plurality of first average values.

In some implementations, the first reference value may be a median value of the plurality of first average values.

In some implementations, the pixel data calculator may further determine a plurality of second average values each second average value corresponding to an average of the dark pixel values of pixels in a respective second pixel group, each second pixel group being a set of pixels arranged in a line in a second direction different from the first direction within the matrix structure; the parameter determiner may further determine one or more second delta values by subtracting a second reference value from each of the plurality of second average values; and the pixel data corrector may further generate second corrected pixel values by adjusting each of the first corrected pixel values using the second delta value.

In some implementations, the second reference value may be an average of the plurality of second average values.

In some implementations, the second reference value may be a median value of the plurality of second average values.

In some implementations, the first reference value may be a preset offset value.

In some implementations, the pixel data corrector may generate the first corrected pixel values by subtracting the first delta value from the dark pixel value of each of the plurality of pixels.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an imaging device and an image correction device based on some embodiments of the disclosed technology.

FIG. 2 is a flowchart illustrating an example of a method for operating the image correction device shown in FIG. 1 based on some embodiments of the disclosed technology.

FIG. 3A is a diagram illustrating an example result of performing operation S210 of FIG. 2 based on some embodiments of the disclosed technology.

FIG. 3B is a diagram illustrating an example result of performing operation S220 of FIG. 2 based on some embodiments of the disclosed technology.

FIG. 3C is a diagram illustrating an example result of performing operation S230 of FIG. 2 based on some embodiments of the disclosed technology.

FIG. 3D is a diagram illustrating an example result of performing operation S260 of FIG. 2 based on some embodiments of the disclosed technology.

FIG. 3E is a diagram illustrating an example result of performing operation S270 of FIG. 2 based on some embodiments of the disclosed technology.

FIG. 4A is a diagram illustrating an example result of performing operation S240 of FIG. 2 based on an embodiment in which the first direction is a row direction.

FIG. 4B is a diagram illustrating an example result of performing operation S240 of FIG. 2 based on an embodiment in which the first direction is a column direction.

FIG. 4C is a diagram illustrating an example result of performing operations S240 and S280 of FIG. 2 based on some embodiments of the disclosed technology.

FIG. 5 is a flowchart illustrating an example of a method for operating the imaging device shown in FIG. 1 based on some embodiments of the disclosed technology.

### DETAILED DESCRIPTION

This patent document provides embodiments and examples of an imaging device including an image sensor for generating pixel signals and an image correction device for correcting a noise deviation between the pixel signals and an image correction method using the same, which may be used in configurations to substantially address one or more technical or engineering issues and to mitigate limitations or disadvantages encountered in some imaging devices. Some embodiments of the disclosed technology relate to the imaging device that can prevent the occurrence of incorrect images caused by non-uniform noise generated in a pixel array. In recognition of the issues above, some embodiments of the disclosed technology provide the image correction device that can generate more uniform images by correcting the noise deviation according to the positions of pixels included in the pixel array.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

In describing the components of the embodiments of the disclosed technology, terms such as “first” and “second” may be used to distinguish one component from another and are not used to limit the components. Unless otherwise specified, such terms do not imply any particular order or importance, etc. of the components.

Recently, with the growing demand for high-quality pixel image sensors, the size of semiconductor chips used in image sensors has also increased. However, this trend introduces a challenge. For example, a noise deviation based on pixel location within the semiconductor chip becomes more severe as the location-dependent factors (e.g., voltage drop) have a greater impact.

To address the aforementioned noise deviation, in some implementations, the noise deviation is corrected using hardware or software that analyzes the degree of noise generated in pixels included in a pixel array of the image sensor. Some embodiments of the disclosed technology provide an imaging device that includes an image sensor designed to generate pixel signals and an image correction device designed to correct a noise deviation between the pixel signals, and an image correction method using the imaging device.

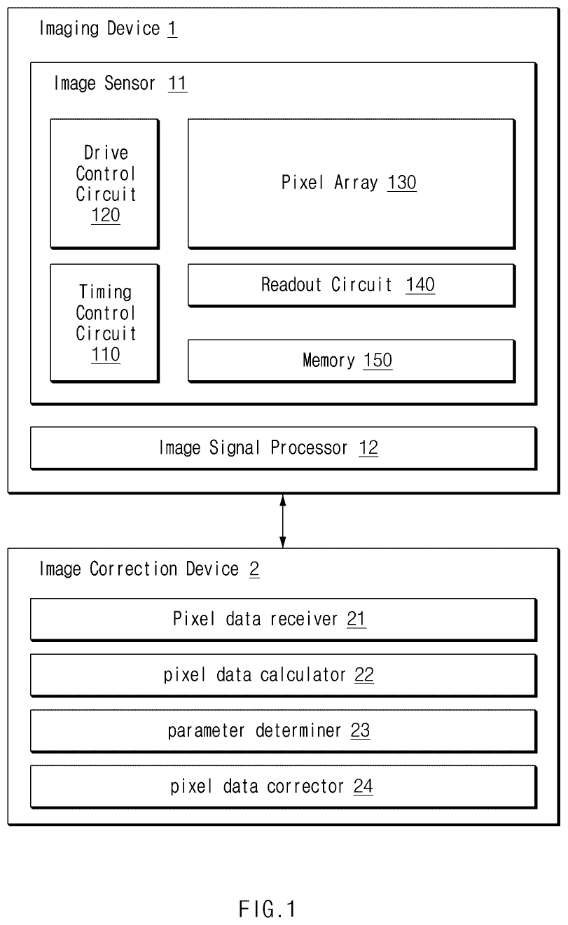

Hereinafter, embodiments of the disclosed technology will be described in detail with reference to FIGS. 1 to 5.

FIG. 1 is a block diagram illustrating an imaging device 1 and an image correction device 2 based on some embodiments of the disclosed technology.

Referring to FIG. 1, the imaging device 1 according to one embodiment of the disclosed technology may include an image sensor 11 and an image signal processor (ISP) 12. The imaging device 1 may be any one of electronic devices that include a photographing function, such as a camera, a smartphone, and the like.

The image sensor 11 may include a timing control circuit 110, a drive control circuit 120, a pixel array 130, a readout circuit 140, and a memory 150. Although the memory 150 may be provided separately from the image sensor 11 within the imaging device 1, the following description will illustrate, by way of example, an embodiment in which the memory 150 is disposed within the image sensor 11.

The timing control circuit 110 may provide timing signals and control signals to at least one of the drive control circuit 120 and the readout circuit 140.

The drive control circuit 120 may activate the pixel array 130 to perform specific operations on pixels included in a corresponding row based on the timing signals and the control signals provided from the timing control circuit 110.

The pixels of the row selected by the drive control circuit 120 may sequentially transfer analog reference signals and analog image signals to the readout circuit 140. The reference signals may be provided to the readout circuit 140 when a floating diffusion region of each pixel is reset to a power-supply voltage VDD. The image signals may be provided to the readout circuit 140 when photocharges generated by each pixel are accumulated in the floating diffusion region (FD).

The reference signals may indicate unique pixel noise. In some embodiments, the reference signals and the image signals may be collectively referred to as “pixel signal.”

The pixel array 130 may include a plurality of pixels arranged in a plurality of rows and a plurality of columns. The plurality of pixels may be connected to the drive control circuit 120 through a plurality of row lines extending in the row direction. The plurality of pixels may be connected to the readout circuit 140 through a plurality of column lines extending in the column direction.

Each of the plurality of pixels included in the pixel array 130 may output a pixel signal in response to incident light. The plurality of pixels may be arranged in a two-dimensional (2D) array. For example, each of the plurality of pixels may be arranged in a matrix structure. The plurality of pixels may be arranged in a first direction and a second direction. For example, the plurality of pixels may be arranged in a row direction and a column direction.

The photoelectric conversion element may generate photocharges in response to incident light. The pixel may output an electrical signal corresponding to the amount of generated photocharges.

When a pixel operates under a dark condition where the amount of incident light is very low or absent, the pixel may generate a dark signal due to a noise component generated inside the image sensor 11.

As the number of pixels included in the pixel array 130 increases and the overall area of the pixel array 130 increases, the deviation in noise components between pixels may increase depending on their positions within the pixel array 130. This increased deviation in noise components can lead to a reduction in the quality of the image generated from a plurality of pixel signals, which is generated from the pixel array 130.

The readout circuit 140 may sample electrical signals output from the pixel array 130, may convert the sampled electrical signals into digital signals, and may output the digital signals to an image signal processor (ISP). The readout circuit 140 may include, for example, a correlated double sampler (CDS), an analog-to-digital converter (ADC), an output buffer, a column driver, etc.

In some embodiments, the CDS may receive the reference signals and the image signals corresponding to the columns of the pixel array 130, and may sample levels of the reference signals and the image signals. For example, when one row of the pixel array 130 is selected by the drive control circuit 120, each pixel in the selected row outputs a reference signal and an image signal through a corresponding column line. The reference signal and the image signal are thus generated as analog voltages corresponding to respective columns of the pixel array 130. The correlated double sampler (CDS) may receive, for each column, the reference and image signals output from the pixels connected to that column line, and may sample and hold the levels of the reference and image signals to perform noise reduction for each column.

The CDS may transmit reference signals and image signals, which are generated for each column based on a timing signal and a control signal of the timing control circuit 110, to the ADC as CDS signals.

For example, the ADC may convert analog CDS signals received from the CDS into digital signals, and may output the resultant digital signals. The output buffer may temporarily hold and output digital signals provided from the ADC. The column driver may select columns from the output buffer based on a timing signal and a control signal of the timing control circuit 110, and may control the temporarily held digital signals to be output according to the order of selection.

The memory 150 may include a storage device configured to store data therein. The memory 150 may store correction parameters (e.g., correction gain) to be used for image correction.

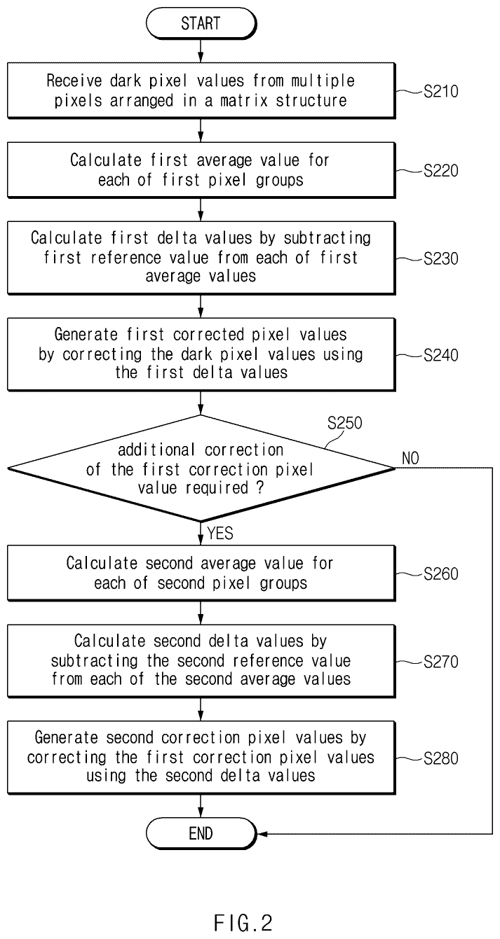

The memory 150 may store correction parameters for correcting noise deviation for each pixel (e.g., per-pixel noise deviation) based on the positions of pixels within the pixel array 130. In some implementations, the correction parameters may be stored in different sets depending on the operating conditions of the image sensor 11. For example, the correction parameters for a pixel at a specific position in the pixel array 130 may have different values between room temperature (e.g., 25 °C) and high temperature (e.g., 60 °C) conditions. A more detailed description of the correction parameters will be provided below with reference to FIG. 2.

The image signal processor (ISP) 12 may be a device that corrects data (e.g., raw image) output from the image sensor 11. In an embodiment, the image signal processor 12 may read data regarding the correction parameters stored in the memory 150 and may reduce noise deviation of pixels located at different positions within the pixel array 130.

The image correction device 2 may enable the imaging device 1 to determine correction parameters for image correction. The image correction device 2 may receive pixel values (e.g., dark pixel values generated under a dark condition) from the pixel array 130, and may correct the pixel values to generate a corrected image.

The image correction device 2 may include a pixel data receiver 21, a pixel data calculator 22, a parameter determiner 23, and a pixel data corrector 24.

The pixel data receiver 21 may receive pixel values (e.g., dark pixel values) generated by the plurality of pixels arranged in the pixel array 130. Each of the plurality of pixels may generate a pixel signal in an analog form. The pixel signal may be sampled and quantized by the readout circuit 140, so that the pixel signal can be converted into a digital signal having a pixel value denoted by a discrete numerical value. The pixel value may increase as the intensity of the analog signal increases, and may decrease as the intensity of the analog signal decreases.

The pixel data calculator 22 may calculate an average of dark pixel values generated by pixels arranged in a specific direction within the pixel array 130. In an embodiment, the plurality of pixels in the pixel array 130 is arranged in a matrix structure, and the pixel data calculator 22 may calculate a first average value, defined as the average of dark pixel values generated by a first pixel group, which is a set (aggregation) of pixels arranged in a first direction within the matrix structure. A plurality of such first pixel groups may be present.

For example, the first direction may be a row direction of the matrix structure. The first pixel group may be defined as a set of multiple pixels linearly arranged in a single row.

In another example, the first direction may be a column direction of the matrix structure. The first pixel group may be a set of multiple pixels linearly arranged in a single column.

The pixel data calculator 22 may also calculate a second average value, defined as the average of a plurality of first corrected pixel values obtained when the dark pixel values generated by a second pixel group, which is a set of the pixels arranged in the second direction within the matrix structure are respectively corrected. The second direction may be different from the first direction. A plurality of such second pixel groups may be present.

For example, when the first direction is the row direction, the second direction may be the column direction. In such a case, the second pixel group may be a set of multiple pixels linearly arranged in a single column.

In another example, when the first direction is the column direction, the second direction may be the row direction. In such a case, the second pixel group may be a set of a plurality of pixels linearly arranged in a single row.

The parameter determiner 23 may determine correction parameters for correcting the noise deviation for each pixel (e.g., per-pixel noise deviation) according to the positions of pixels within the pixel array 130. For example, the parameter determiner 23 may calculate a predetermined delta value as a correction parameter for correcting a predetermined average value calculated by the pixel data calculator 22, based on a preset reference value.

The pixel values generated by the plurality of pixels may vary depending on the operating conditions of the image sensor 11, and as a result, the above average value may also vary. In some embodiments, the parameter determiner 23 may calculate a delta value for the first pixel group, and may further calculate a delta value for the second pixel group. A more detailed description of the calculation operation in which the parameter determiner 23 calculates the delta value will be provided below with reference to FIG. 2.

The pixel data corrector 24 may correct pixel values using the delta values calculated by the parameter determiner 23. For example, the pixel data corrector 24 may correct the pixel values generated by the pixels based on the first delta values calculated for the first pixel groups. In another example, the pixel data corrector 24 may correct the pixel values generated by the pixels based on the second delta values calculated for the second pixel groups. In another example, the pixel data corrector 24 may first correct the pixel values generated by pixels using the first delta values calculated for the first pixel groups to generate the initially corrected values (hereinafter referred to as “first corrected pixel value”), and then re-correct the first corrected pixel value using the second delta values calculated for the second pixel groups, thereby generating a second corrected pixel value.

In an embodiment, the pixel data corrector 24 may calculate the first corrected pixel values by subtracting the first delta values from the pixel values generated by the respective pixels. The pixel data corrector 24 may calculate the second corrected pixel values by subtracting the second delta values from the first corrected pixel values for the respective pixels.

FIG. 2 is a flowchart illustrating an example of a method for operating the image correction device 2 shown in FIG. 1 based on some embodiments of the disclosed technology.

Referring to FIGS. 1 and 2, the pixel data receiver 21 may receive dark pixel values generated by multiple pixels arranged in a matrix structure (Operation S210). The multiple pixels may be pixels arranged in a matrix structure within the pixel array 130, and may refer to active pixels arranged in the pixel array 130.

The active pixel may refer to a pixel that generates a pixel signal in response to incident light. By contrast, the optical black pixel may be a pixel that does not generate such a pixel signal in response to incident light due to a light blocking structure. In some implementations, when the active pixel outputs a pixel signal, the optical black pixel may be used to output the noise component inherent to the pixel.

The dark pixel value may refer to a value obtained by converting, into a digital signal, a pixel signal generated by each of the multiple pixels under a dark condition.

The matrix structure may be a structure in which the multiple pixels are arranged in a two-dimensional (2D) structure. The matrix structure may be an (M ×N) matrix structure (where each of ‘M’ and ‘N’ is an integer equal to or greater than 2). In the matrix structure, M pixels may be arranged in the first direction, and N pixels may be arranged in the second direction. In one example, the first direction may refer to the row direction of the pixel array 130, and the second direction may refer to the column direction of the pixel array 130. In another example, the first direction may refer to the column direction of the pixel array 130, and the second direction may refer to the row direction of the pixel array 130.

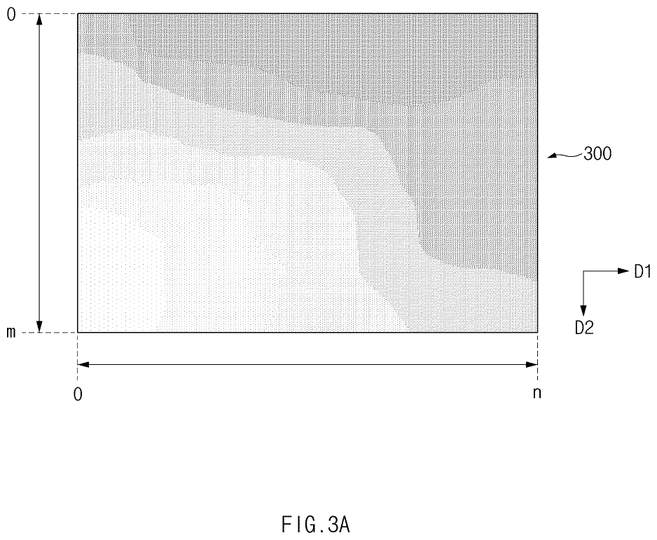

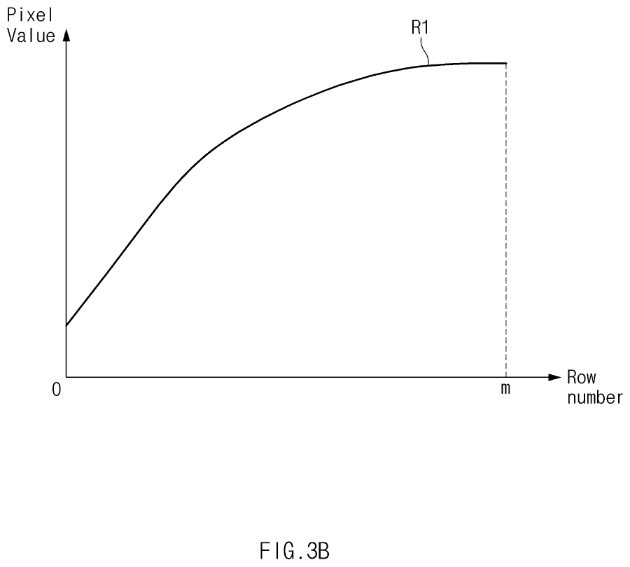

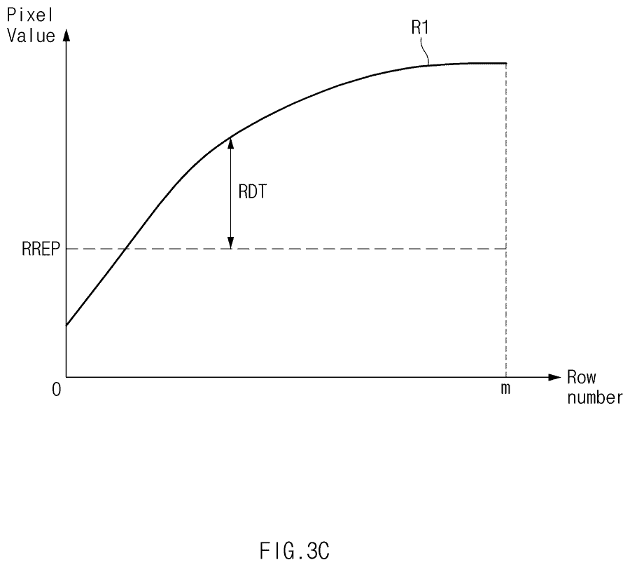

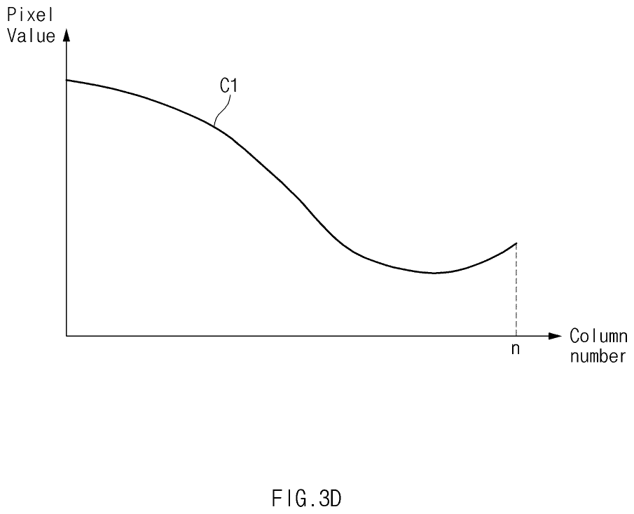

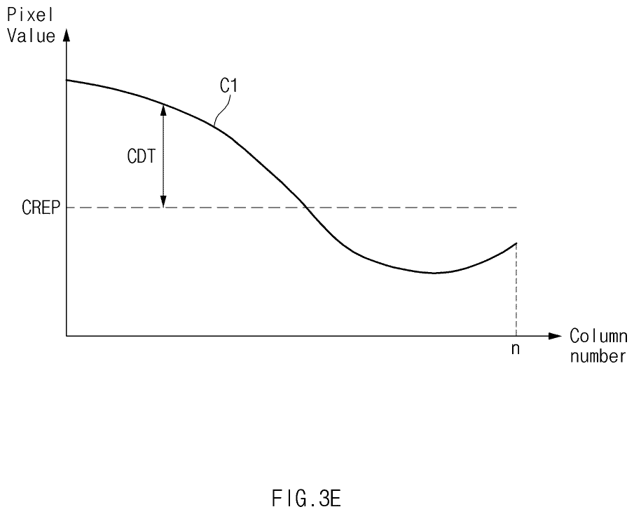

In some embodiments, the pixel array having the M×N matrix structure may generate pixel data such as dark pixel values corresponding to each pixel under a dark condition. The set of such pixel data arranged in the M×N matrix structure may be referred to as a dark image representing noise generated by the pixels inside the image sensor (e.g., dark image 300 shown in FIG. 3A). Therefore, the dark image represents the two-dimensional array of pixel outputs obtained from the M×N pixel array structure of the image sensor.

Hereinafter, an embodiment in which the first direction is the row direction and the second direction is the column direction will be described with reference to FIG. 2.

The pixel data calculator 22 may calculate a first average value for each of the plurality of first pixel groups (Operation S220). Each of the plurality of first pixel groups may be a set of pixels arranged in the first direction within the matrix structure. For each first pixel group, the pixel data calculator 22 may calculate first average values, representing the average of the dark pixel values of the pixels included in the corresponding first pixel group (Operation S220). In an (M×N) matrix structure (where ‘M’ and ‘N’ are integers greater than or equal to 2), the first pixel group may refer to a set of pixels linearly arranged in the row direction. Since the matrix structure includes M rows, a plurality of first pixel groups (e.g., M first pixel groups) may be present. When the pixel data calculator 22 calculates the average of the dark pixel values for each of the M first pixel groups, each of M first average values may be obtained.

The parameter determiner 23 may calculate first delta values by subtracting a first reference value from each of the plurality of first average values (Operation S230). In an embodiment, the first reference value may be defined as the average of the first average values. The average of the first average values may be equal to the average of the dark pixel values of all pixels. In another embodiment, the first reference value may be a median value of the first average values. In another embodiment, the first reference value may be a preset offset value. The offset value may be arbitrarily preset by a user of the image correction device 2. For example, the user of the image correction device 2 may determine an offset value based on a theoretical ideal value of a dark pixel value obtained by a pixel under a dark condition.

In an embodiment, the first reference value is set as an offset value and image correction is performed according to the method of FIG. 2. In such a case, if the user sets the offset value to the ideal pixel value expected under a dark condition, the first corrected pixel values (resulting from operation S240) may be closest to the ideal outcome.

In an embodiment, when the overall average of the dark pixel values significantly differs from the ideal value, the ideal value is set as the offset value and is used as a first reference value. As a result, incorrect correction results may be obtained during the execution of operations (S260-S280). Therefore, when the overall average of the dark pixel values deviates considerably from the ideal value, the first reference value may be set to the median or average of the first average values, and image correction may be performed according to the method of FIG. 2. Although not shown in FIG. 2, the image correction device 2 may first perform an operation of determining a first reference value before calculating the first delta values. As previously described, the criterion for determining the first reference value may be based on the difference between the ideal value and the overall average of the dark pixel values.

Each of the first reference value, the first average values, and the first delta values may satisfy Equation 1 below. Since the first reference value is subtracted from each of the first average values for each of the M first pixel groups respectively corresponding to the M rows in the (M×N) matrix structure, M first delta values may be calculated.

(first delta value)=(first average value)−(first reference value) [Equation 1]

The pixel data corrector 24 may generate (or calculate) first corrected pixel values by correcting the dark pixel values using the first delta values (Operation S240). For example, the pixel data corrector 24 may calculate the first corrected pixel values by subtracting the first delta value from dark pixel values for each pixel. When correcting the dark pixel values for each pixel, the first delta value corresponding to the first pixel group to which the pixel belongs may be subtracted to obtain the first corrected pixel value.

Each of the first corrected pixel values may satisfy Equation 2 below.

(first corrected pixel value)=(dark pixel value)−(first delta value) [Equation 2]

The pixel data corrector 24 may determine whether the first corrected pixel values require additional correction (Operation S250). For example, the image correction device may compare a predetermined threshold with a difference between a maximum value and a minimum value among the plurality of first corrected pixel values calculated in operation S250, and may determine whether additional correction is required based on the result of such comparison. If a significant deviation remains among the first corrected pixel values even after the correction performed in operation S240, additional correction may be required.

If additional correction of the first corrected pixel values is required (YES in S250), the pixel data calculator 22 may calculate a second average value for each of the plurality of second pixel groups (Operation S260). The second pixel groups may be a set of pixels arranged in the second direction within the matrix structure. For each second pixel group, the pixel data calculator 22 may calculate second average values, representing the average values of dark pixel values of pixels included in the corresponding second pixel group (Operation S260).

While FIG. 2 illustrates an embodiment in which the operation S260 for calculating the second average values is performed after operation S250, which determines whether additional correction of the first corrected pixel values is required by way of example, in another embodiment, the operation S260 for calculating the second average values may be performed prior to operation S250. For example, the operation S260 may be carried out between operations S220 and S250.

In the (M×N) matrix structure, the second pixel group may refer to a set of pixels linearly arranged in the column direction. Since the matrix structure includes N columns, there may be multiple (e.g., N) second pixel groups.

For example, the second average value corresponding to a second pixel group, defined as a set of pixels arranged in the first column, may be calculated and obtained by the pixel data calculator 22, by averaging the dark pixel values corresponding to the plurality of pixels arranged in the first column.

The second average value corresponding to a second pixel group, defined as a set of pixels arranged in the second column, may be calculated and obtained by the pixel data calculator 22, by averaging the dark pixel values corresponding to each of the plurality of pixels arranged in the second column.

The expression “first corrected pixel value corresponding to each of the plurality of pixels” may refer to first corrected pixel values obtained when the dark pixel values generated by pixels are corrected in operation S240. Since a second average value can be calculated for each of the N second pixel groups, N second average values may be calculated.

The parameter determiner 23 may calculate second delta values by subtracting a second reference value from each of the second average values (Operation S270). In an embodiment, the second reference value may be the average of the second average values. The average of the second average values may be equal to the average of the dark pixel values of all pixels. In another embodiment, the second reference value may be the median value of the second average values. In another embodiment, the second reference value may be a preset offset value. The offset value may be arbitrarily set (or determined) in advance by a user of the image correction device 2. For example, the user of the image correction device 2 may determine an offset value as a theoretical ideal value of a dark pixel value obtained by a pixel under a dark condition.

Each of the second reference value, the second average values, and the second delta values may satisfy Equation 3 below. Since the second reference value is subtracted from each of the second average values for N second pixel groups corresponding to N columns in the (M×N) matrix structure, N second delta values may be calculated.

(second delta value)=(second average value)−(second reference value) [Equation 3]

The pixel data corrector 24 may generate (calculate) second corrected pixel values by correcting the first corrected pixel values using the second delta values (Operation S280). For example, the pixel data corrector 24 may calculate the second corrected pixel values by subtracting the second delta value from the first corrected pixel values for each pixel. When correcting the first corrected pixel values for each pixel, the second corrected pixel value may be calculated by subtracting the second delta values of the second pixel group to which the corresponding pixel belongs.

Each of the second corrected pixel values may satisfy Equation 4 below

(second corrected pixel value)=(first corrected pixel value)−(second delta value) [Equation 4]

If additional correction of the first corrected pixel values is not necessary (NO in S250), the pixel data corrector 24 may terminate the correction operation.

FIG. 3A is a diagram illustrating an example result of performing the operation S210 of FIG. 2 based on some embodiments of the disclosed technology.

Referring to FIGS. 1, 2, and 3A, the dark image 300 may be an image that includes the dark pixel values received by the pixel data receiver 21 from the pixel array 130 in which the multiple pixels are arranged in a matrix structure. The dark image 300 may be an image having a resolution of (M×N). Here, ‘M’ may represent the number of first pixel groups, each of which is a set of pixels linearly arranged in the row direction (D1) of the pixel array 130. Here, ‘N’ may represent the number of second pixel groups, each of which is a set of pixels linearly arranged in the column direction (D2) of the pixel array 130.

The dark image 300 is a raw image captured prior to any correction operation, and the magnitudes of the dark pixel values of the pixels may vary depending on the positions of the pixels within the pixel array 130.

FIG. 3B is a diagram illustrating an example result of performing operation S220 of FIG. 2 based on some embodiments of the disclosed technology.

Referring to FIGS. 1, 2, 3A, and 3B, a row curve (R1) is a graph representing the result of calculating, by the pixel data calculator 22, a first average value of the dark pixel values for each of the M first pixel groups included in the dark image 300. In this graph, a horizontal axis may represent which row the M first pixel groups are located in, and a vertical axis may represent first average values for the respective first pixel groups.

FIG. 3C is a diagram illustrating an example result of performing operation S230 of FIG. 2 based on some embodiments of the disclosed technology.

Referring to FIGS. 1, 2, 3B, and 3C, the parameter determiner 23 may calculate first delta values (RDT) by subtracting a first reference value (RREP) from each of the first average values (e.g., the vertical axis values of points on the row curve R1) according to Equation 1. The parameter determiner 23 may calculate the first delta values (RDT) for the first pixel groups for each row.

In an embodiment, the first reference value (RREP) may be a preset offset value as described in FIG. 1. In another embodiment, the first reference value (RREP) may be the median value of the first average values. In another embodiment, the first reference value (RREP) may be the average of the first average values.

FIG. 3D is a diagram illustrating an example result of performing operation S260 of FIG. 2 based on some embodiments of the disclosed technology.

Referring to FIGS. 1, 2, 3A, and 3D, a column curve (C1) is a graph representing the result of calculating, by the pixel data calculator 22, second average values, each of which indicates the average of the dark pixel values corresponding to pixels included in each of the N second pixel groups included in the dark image 300. In this graph, a horizontal axis may represent which column the N second pixel groups are located in, and a vertical axis may represent second average values for the respective second pixel groups.

FIG. 3E is a diagram illustrating an example result of performing operation S270 of FIG. 2 based on some embodiments of the disclosed technology.

Referring to FIGS. 1, 2, 3D, and 3E, the parameter determiner 23 may calculate second delta values (CDT) by subtracting a second reference value (CREP) from each of the second average values (e.g., the vertical axis values of arbitrary points on the column curve C1) according to Equation 3. The parameter determiner 23 may calculate the second delta values (RDT) for the second pixel groups for each column.

In an embodiment, the second reference value (CREP) may be a preset offset value as described in FIG. 2. In another embodiment, the second reference value (CREP) may be the median value of the second average values. In another embodiment, the second reference value (CREP) may be the average of the second average values.

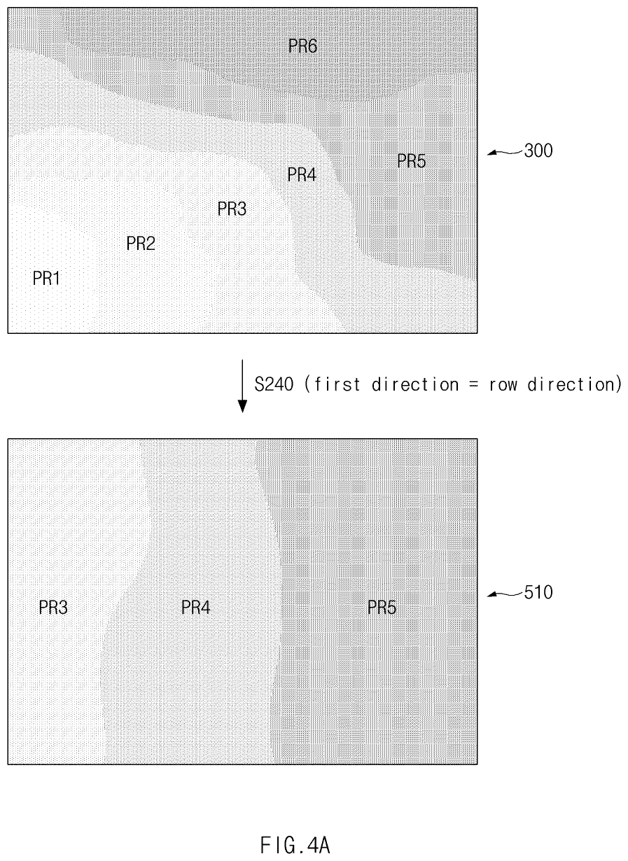

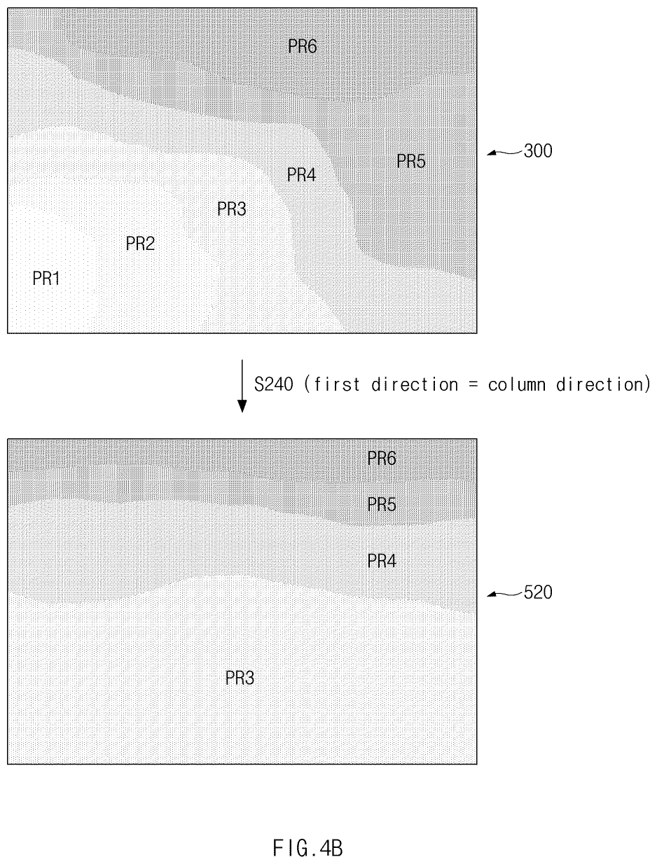

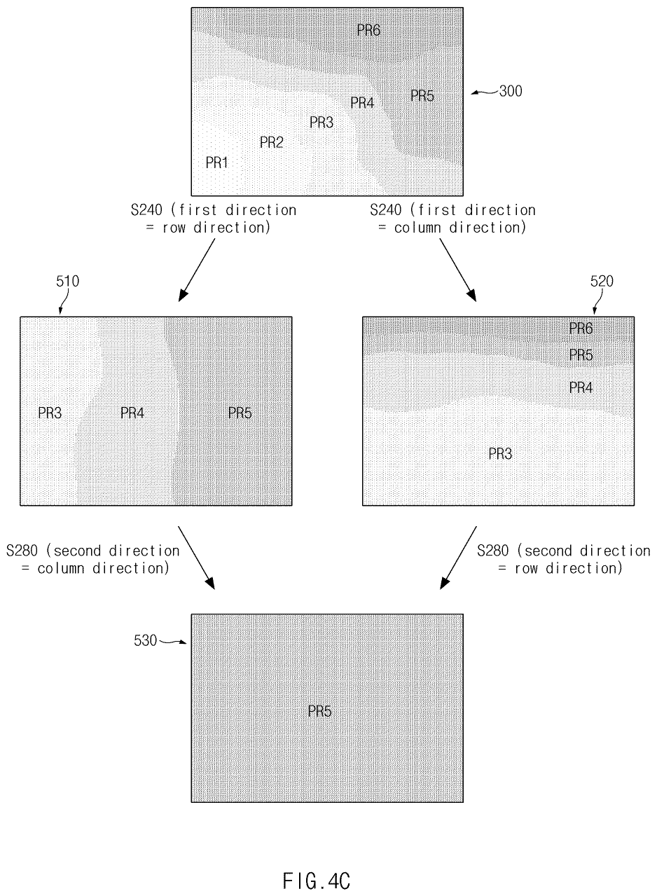

FIG. 4A is a diagram illustrating an example result of performing operation S240 of FIG. 2 based on an embodiment in which the first direction (D1) is the row direction.

Referring to FIGS. 1, 2, 3A, and 4A, the first corrected image 510 may be an image composed of the first corrected pixel values, which are calculated by the pixel data corrector 24 by subtracting the first delta values from the dark pixel values. When the first direction is the row direction in operation S220, the first delta values may be values calculated in operation S230. Although the dark image 300 is described as having dark pixel values that belong to any one of first to sixth ranges (PR1-PR6) by way of example, other implementations are also possible, and it should be noted that the pixel value ranges for these six ranges may vary as needed.

The pixel values converted into digital signals through the readout circuit 140 may range, for example, from 0 to 1023. Since dark pixel values are generated under a dark condition, they may fall within a narrower range, for example, from 63 to 68. However, such numerical ranges are provided merely as examples, and the disclosed technology is not limited thereto.

In an embodiment, the first range (PR1) may refer to a range of 66.0 or higher. The second range (PR2) may refer to a range from 65.0 (inclusive) to less than 66.0. The third range (PR3) may refer to a range from 64.5 to less than 65.0. The fourth range (PR4) may refer to a range from 64.25 to less than 64.5. The fifth range (PR5) may refer to a range from 64.0 to less than 64.25. The sixth range (PR6) may refer to a range of less than 64.0.

When the first corrected image 510, obtained through operations S210 to S240, is compared with the dark image 300, it can be observed that correcting the dark pixel values using the first delta values calculated for each of the M rows may reduce the deviation of pixel values among multiple pixels located within the same column.

The first average value may refer to the average of dark pixel values among the pixels arranged in the same row and the first delta value is subtracted from the first average value. Accordingly, after a pixel having a dark pixel value higher than the first reference value is corrected, a pixel value of the corrected pixel may decrease, and after a pixel having a dark pixel value less than the first reference value is corrected, a pixel value of the corrected pixel may increase.

Since the same first reference value is used for all rows and each row is arranged in the column direction, the deviation in dark pixel values among pixels located in the same column may be reduced after image correction.

FIG. 4B is a diagram illustrating an example result of performing operation S240 of FIG. 2 based on an embodiment in which the first direction is the column direction.

Referring to FIGS. 1, 2, 3A, and 4A, the second corrected image 520 may be an image composed of the first corrected pixel values, which are calculated by the pixel data corrector 24 by subtracting the first delta values from the dark pixel values.

The first delta value may be a value calculated in operation S230 when the first direction is the column direction in operation S220. The dark image 300 may be the same image as the dark image 300 shown in FIG. 4A.

When the second corrected image 520 obtained through operations S210 to S240 is compared with the dark image 300, it can be observed that correcting the dark pixel values using the first delta values calculated for each of the N columns may reduce the deviation of pixel values among multiple pixels located within the same row.

The first average value may refer to the average of dark pixel values among the pixels arranged in the same column and the first delta value is subtracted from the first average value. Accordingly, after a pixel having a dark pixel value higher than the first reference value is corrected, a pixel value of the corrected pixel may decrease, and after a pixel having a dark pixel value less than the first reference value is corrected, a pixel value of the corrected pixel may increase.

Since the same first reference value is used for all columns and each column is arranged in the row direction, the deviation in dark pixel values among pixels located in the same row may be reduced after image correction.

FIG. 4C is a diagram illustrating an example result of performing operations S240 and S280 of FIG. 2 based on some embodiments of the disclosed technology.

Referring to FIGS. 1, 2, 3A, and 4C, after the pixel data corrector 24 calculates the first corrected pixel values by subtracting the first delta values from the dark pixel values, the third corrected image 530 may be generated by further subtracting the second delta values from the first corrected pixel values to obtain the second corrected pixel values. Accordingly, the third corrected image 530 can be composed of the second corrected pixel values.

In an embodiment, the first delta values may be values calculated in operation S230 when the first direction is the row direction in operation S220. The second delta values may be values calculated in operation S270 when the second direction is the column direction in operation S260.

In another embodiment, the first delta values may be values calculated in operation S230 when the first direction is the column direction in operation S220. The second delta values may be values calculated in operation S270 when the second direction is the row direction in operation S260.

When the first direction is the row direction in operation S220, the first corrected image 510 may be generated through the operation S240. In this case, the second direction in operation S260 may correspond to the column direction, and the third corrected image 530 may be generated through operations S260 to S280.

When the first direction is the column direction in operation S220, the second corrected image 520 may be generated through the operation S240. In this case, the second direction in operation S260 may correspond to the row direction, and the third corrected image 530 may be generated through operations S260 to S280.

When the third corrected image 530 is compared with the first and second corrected images (510, 520), the third corrected image 530 may be a corrected image in which the pixel value deviation among multiple pixels after image correction is significantly reduced compared to the first corrected image 510 or the second corrected image 520.

Because the correction is performed in only one step, the first and second corrected images (510, 520) may be generated more quickly than the third corrected image 530, which undergoes two steps of correction.

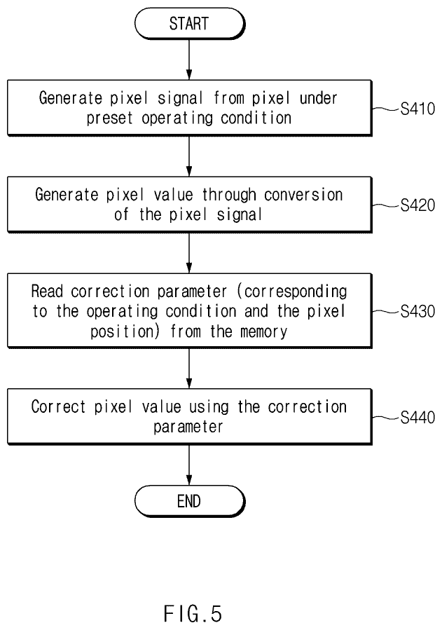

FIG. 5 is a flowchart illustrating an example of a method for operating the imaging device 1 shown in FIG. 1 based on some embodiments of the disclosed technology.

Referring to FIGS. 1, 2, and 5, the image sensor 11 may generate a pixel signal using a pixel disposed within the pixel array 130 under predetermined operating conditions (Operation S410). The predetermined operating conditions may include, for example, the internal temperature of the pixel array 130 during the operation, the exposure time, and the conversion gain of the pixel. Although not shown in FIG. 1, the imaging device 1 may include a temperature sensor. The temperature sensor may measure the internal temperature of the pixel array 130.

The image sensor 11 may convert the pixel signal generated in operation S410 into a digital signal through the readout circuit 140 to generate a pixel value (Operation S420).

The image signal processor 12 may read, from the memory 150, correction parameters corresponding to the operating condition of operation S410 and the position of the pixel (Operation S430). The memory 150 may store correction parameters for each pixel. The correction parameters may include the operating conditions for each pixel. The correction parameters may include the first delta value and the second delta value that are calculated according to the method of FIG. 2 under predetermined operating conditions. That is, the memory 150 may store the first delta value and the second delta value for each operating condition. The first and second delta values per operating condition may be pre-calculated for each operation condition of each pixel using the image correction device 2 and then stored in the memory 150.

The image correction device 2 may correct the pixel value using the correction parameters (Operation S440). In the pixel array 130 in which multiple pixels are arranged in an (M×N) matrix structure, when the operating conditions of the pixel array 130 are as follows: a room temperature range (20 °C to 30 °C); the exposure time is 100 ms; and the conversion gain of the pixel located at the k-th row and the g-th column is 1.5, the readout operation is performed. As a result, the pixel value generated by the corresponding pixel located at the k-th row and the g-th column and converted into a digital signal, can be corrected using: a first value corresponding to the above operating condition among the first delta values of the k-th row; and a second value corresponding to the above operating condition among the second delta values of the g-th column (where ‘k’is an integer from 1 to M, and ‘g’ is an integer from 1 to N).

As is apparent from the above description, the image correction device according to the embodiments of the disclosed technology may generate more uniform images by correcting noise deviation based on the positions of pixels included in the pixel array.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image correction method comprising:
receiving, by an image correction device, from a plurality of pixels arranged in a matrix structure, dark pixel values corresponding to pixel signals generated under a dark condition by the plurality of pixels;
processing the received dark pixel values, by the image correction device, to determine a plurality of first average values for first pixel groups each being a set of pixels arranged in a line in a first direction within the matrix structure, wherein each first average value corresponds to an average of the dark pixel values of pixels in a respective first pixel group within the plurality of pixels arranged in the matrix structure;
determining, by the image correction device, one or more first delta values by subtracting a first reference value from each of the plurality of first average values; and
generating, by the image correction device, first corrected pixel values by adjusting each of the dark pixel values using the first delta values.

2. The image correction method according to claim 1, wherein the determining the first delta values includes:
calculating the first delta values by using a median value of the plurality of first average values as the first reference value.

3. The image correction method according to claim 1, wherein the determining the first delta values includes:
calculating the first delta values by using an average of the plurality of first average values as the first reference value.

4. The image correction method according to claim 1, further comprising
determining, by the image correction device, a plurality of second average values, each second average value corresponding to an average of the dark pixel values of pixels in a respective second pixel group, each second pixel group being a set of pixels arranged in a line in a second direction different from the first direction within the matrix structure;
determining, by the image correction device, one or more second delta values by subtracting a second reference value from each of the plurality of second average values; and
generating, by the image correction device, second corrected pixel values by adjusting each of the first corrected pixel values using the second delta value.

5. The image correction method according to claim 4, wherein the determining the second delta value includes:
calculating the second delta value by using a median value of the plurality of second average values as the second reference value.

6. The image correction method according to claim 4, wherein the determining the second delta value includes:
calculating the second delta value by using an average of the plurality of second average values as the second reference value.

7. The image correction method according to claim 4, wherein:
the determining the first delta values includes:
calculating the first delta value by using a preset offset value as the first reference value, and
the determining the second delta value includes:
calculating the second delta value by using the preset offset value as the second reference value.

8. The image correction method according to claim 4, wherein the generating the second corrected pixel values includes:
calculating the second corrected pixel values by subtracting the second delta value from the first corrected pixel value of each of the plurality of pixels.

9. The image correction method according to claim 1, wherein the generating the first corrected pixel values includes:
calculating the first corrected pixel values by subtracting the first delta value from the dark pixel value of each of the plurality of pixels.

10. An image correction device comprising:
a pixel data receiver configured to receive dark pixel values corresponding to pixel signals generated under a dark condition by a plurality of pixels arranged in a matrix structure;
a pixel data calculator configured to process the received dark pixel values to determine a plurality of first average values for first pixel groups each being a set of pixels arranged in a line in a first direction within the matrix structure, wherein each of the first average values is an average of dark pixel values of a plurality of pixels included in the first pixel group;
a parameter determiner configured to determine one or more first delta values by subtracting a first reference value from each of the plurality of first average values; and
a pixel data corrector configured to generate first corrected pixel values by adjusting each of the dark pixel values using the first delta value.

11. The image correction device according to claim 10, wherein:
the first direction is a row direction in the matrix structure.

12. The image correction device according to claim 10, wherein:
the first direction is a column direction in the matrix structure.

13. The image correction device according to claim 10, wherein:
the first reference value is an average of the plurality of first average values.

14. The image correction device according to claim 10, wherein:
the first reference value is a median value of the plurality of first average values.

15. The image correction device according to claim 10, wherein:
the pixel data calculator further determines a plurality of second average values, each second average value corresponding to an average of the dark pixel values of pixels in a respective second pixel group, each second pixel group being a set of pixels arranged in a line in a second direction different from the first direction within the matrix structure;
the parameter determiner further determines one or more second delta values by subtracting a second reference value from each of the plurality of second average values; and
the pixel data corrector further generates second corrected pixel values by adjusting each of the first corrected pixel values using the second delta value.

16. The image correction device according to claim 15, wherein:
the second reference value is an average of the plurality of second average values.

17. The image correction device according to claim 15, wherein:
the second reference value is a median value of the plurality of second average values.

18. The image correction device according to claim 10, wherein:
the first reference value is a preset offset value.

19. The image correction device according to claim 10, wherein the pixel data corrector is configured to:
generate the first corrected pixel values by subtracting the first delta value from the dark pixel value of each of the plurality of pixels.
